(19) United States
(12) Patent Application Publication
(10) Pub. No.: US 2026/0257346 A1
(43) Pub. Date: Sep. 3, 2026

(54) PROGRAMMABLE MICRO-ROBOT AND ASSEMBLY OF SUCH MICRO-ROBOTS FORMING A MODULAR THREE-DIMENSIONAL STRUCTURE

(71) Applicants: UNIVERSITE DE FRANCHE-COMTE, Besançon (FR); CENTRE NATIONAL DE LA RECHERCHE SCIENTIFIQUE, PARIS (FR); THE REGENTS OF THE UNIVERSITY OF MICHIGAN, ANN ARBOR, MI (US)

(72) Inventors: Julien BOURGEOIS, VOUJEAUCOURT (FR); David BLAAUW, ANN ARBOR, MI (US); Benoît PIRANDA, L'ISLE-SUR-LE-DOUBS (FR); Rémy TRIBHOUT, MONTBELIARD (FR); Goron CARICHNER, SALINE, MI (US); Yimai PENG, ANN ARBOR, MI (US)

(73) Assignees: UNIVERSITE DE FRANCHE-COMTE, Besançon (FR); CENTRE NATIONAL DE LA RECHERCHE SCIENTIFIQUE, PARIS (FR); THE REGENTS OF THE UNIVERSITY OF MICHIGAN, ANN ARBOR, MI (US)

(21) Appl. No.: 18/873,450

(22) PCT Filed: Jun. 9, 2023
(86) PCT No.: PCT/EP2023/065548

§ 371 Date: Dec. 10, 2024

(30) Foreign Application Priority Data
Jun. 11, 2022 (FR) FR2205640

(51) Int. Cl. B25J 9/16; B25J 19/00

(52) U.S. Cl. CPC B25J 9/1617; B25J 19/007

(57) ABSTRACT

A micro-robot including a polyhedral casing, a flexible strip comprising a set of reversible fastening devices called RFDs, each including at least one pair of electrodes and extending between a control unit, contained in the polyhedral casing and arranged to supply the RFDs with power, and at least a part of an outer surface of the polyhedral casing on which the flexible strip extends. The micro-robot is arranged so that at least one RFD emits an electrostatic field by polarization of the at least one pair of electrodes of the at least one RFD. The control unit is arranged to activate and deactivate, individually and for each of the RFDs, the polarization of the at least one pair of electrodes of the at least one RFD so as to activate or deactivate the emission of the electrostatic field by the at least one RFD.

### TECHNICAL FIELD

The present invention belongs to the field of programmable matter.

Programmable matter denotes a reconfigurable modular physical object.

### BACKGROUND

The document by Kirby B. T. et al., (2011), “Blinky blocks: a physical ensemble programming platform”, CHI'11, Extended Abstracts on Human Factors in Computing Systems, pp. 1111-1116 is known in the state of the art. A set of millimetric blocks that can be reversibly assembled by hand is described therein. Certain properties of the blocks, such as emitting a light or a sound, are modified as a function of the ensemble produced.

An aim of the invention is also to propose a programmable ensemble of micro-robots:
capable of being remotely controlled without external manipulation or handling, whether robotic or manual, and/or
in which the micro-robots can interact physically and autonomously with the neighbouring micro-robots, and/or
completely automated and not requiring to work in a controlled environment such as a clean room, and/or
in which the micro-robots are manufactured independently of one another, while retaining the same assembly process, and/or
in which the micro-robots can be customized and in which the programming or the configuration of the micro-robots can be updated while retaining the same assembly process, and/or
in which the micro-robots do not comprise any soldering.

### SUMMARY

To this end, a micro-robot is proposed intended to form part of a programmable ensemble of micro-robots forming a three-dimensional structure with modulable geometry.

The micro-robot comprises:
a polyhedral casing,
a flexible strip:
comprising a set of reversible fastening devices, called RFDs, each comprising at least one pair of electrodes,
extending between a control unit, contained in the polyhedral casing and arranged to supply the RFDs with power, and at least a part of an outer surface of the polyhedral casing on which the flexible strip extends.

The micro-robot is arranged so that at least one RFD emits an electrostatic field by polarization of the at least one pair of electrodes of the at least one RFD.

The control unit is arranged to activate and deactivate, individually and for each of the RFDs, the polarization of the at least one pair of electrodes of the at least one RFD so as to activate or deactivate the emission of the electrostatic field by the at least one RFD.

By “geometry” is meant a spatial conformation or arrangement.

Preferably, the RFDs are distributed along the flexible strip. Preferably, the RFDs are distributed over the whole of the part of the outer surface of the polyhedral casing on which the flexible strip extends.

By “control unit” is meant a microcontroller.

Preferably, each of the micro-robots comprises an individual control unit.

Preferably, the control unit is autonomous. By “autonomous” is meant a control unit not comprising a battery.

In the present application, by “adjacent” is meant in proximity, contiguous, side-by-side or in contact.

Preferably, the flexible strip comprises a printed circuit.

Preferably, the printed circuit electrically connects the RFDs to the control unit.

Preferably, the flexible strip comprises an alternation of flat zones and curved zones.

Preferably, two successive flat zones are connected together by a curved zone.

Preferably, the RFDs extend over the entirety of the flat zones. Preferably, the RFDs extend over the entirety of the curved zones.

Preferably, the flexible strip comprises an inner layer, at least one part of which is in contact with, preferably is attached to, the at least one part of the outer surface of the polyhedral casing.

Preferably, the flexible strip comprises an outer, electrically isolating layer; the outer layer constitutes a part of the outer surface of the micro-robot.

Preferably, the flexible strip comprises an intermediate layer, comprised between the inner layer and the outer layer, comprising an electrically conductive material.

Preferably, the intermediate layer comprises:
electrical tracks formed by the electrically conductive material, and
RFDs formed by the conductive material.

Preferably, the electrical tracks extend along the intermediate layer.

Preferably, the electrodes of the at least one pair of electrodes are adjacent and have inverse polarity.

Preferably, a pair of electrodes comprises at least one negative electrode and at least one positive electrode.

Preferably, the control unit is arranged to generate a supply voltage difference of the RFDs, called high voltage, greater than or equal to 80 volts, preferably 90 volts, more preferably 100 volts.

According to an improvement of the invention, the control unit can comprise:
at least one square pulse generator arranged to supply a charge-pump converter,
a multiplexer, per electrode with negative polarity, arranged so as to, starting from a negative output voltage of the charge-pump converter, generate a negative high voltage and a multiplexer, per electrode with positive polarity, arranged so as to, starting from a positive output voltage of the charge-pump converter, generate a positive high voltage.

According to the invention, a programmable ensemble of micro-robots according to the invention is also proposed, forming a three-dimensional structure with modulable geometry.

For a micro-robot in question situated in proximity to another micro-robot, the electrostatic field emitted by the at least one RFD, of the micro-robot in question, emitting an electrostatic field, exerts a reciprocal attractive force on the at least one RFD of the micro-robot neighbouring the micro-robot in question, emitting an electrostatic field, and reciprocally, such that the micro-robot in question moves along a part of the outer surface formed by an outer layer of the flexible strip of and/or is immobilized against the other micro-robot and/or vice versa and/or reciprocally.

Preferably, the programmable ensemble is constituted by a set of micro-robots.

Preferably, for an RFD of a micro-robot in question, an electrode with negative polarity from a pair of electrodes is intended to cooperate with an electrode with positive polarity from a pair of electrodes of an RFD of another micro-robot, and vice versa or reciprocally.

Preferably, the reciprocal attractive force that is exerted between two adjacent micro-robots is an electrostatic force being exerted between, respectively, the at least one electrode with negative polarity and the at least one electrode with positive polarity of the at least one pair of electrodes of an RFD of the micro-robot in question on, respectively, the at least one electrode with positive polarity and the at least one electrode with negative polarity of an RFD of another micro-robot adjacent to the micro-robot in question.

Preferably, at least a part, preferably the whole, of the outer layer of the flexible strip of a micro-robot is intended to come into contact with at least a part of the outer layer of the flexible strip of another micro-robot.

Preferably, the RFDs extend over the entirety of the flat zones and of the curved zones such that a micro-robot in question moves along the outer layer of the flexible strip of a micro-robot adjacent to the micro-robot in question.

Thus, any characteristic of the micro-robot according to the invention can be transposed directly to the programmable ensemble of micro-robots according to the invention and vice versa.

According to the invention, a method for the manufacture of a micro-robot is also proposed. Preferably, the micro-robot obtained by the manufacturing method is intended to form part of a programmable ensemble of micro-robots forming a three-dimensional structure with modulable geometry according to the invention. The method for the manufacture of the micro-robot comprises the steps consisting of:
electrically connecting a control unit to a flat flexible strip comprising a set of reversible fastening devices, called RFDs,
enclosing the control unit and a part of the flexible strip adjacent to the control unit in a polymer layer in order to immobilize the control unit on the flexible strip, preferably in order to secure the control unit to the part of the flexible strip adjacent to the control unit,
sealing two hemispheres of a polyhedral casing inside which the control unit is housed; the flat flexible strip passes, by means of an opening, through the polyhedral casing, such that a portion of the flat flexible strip extends outside the polyhedral casing,
folding and immobilizing the portion of the flat flexible strip extending outside the polyhedral casing such that it hugs the shape of the polyhedral casing and extends over a part of an outer surface of the polyhedral casing.

Preferably, the step consisting of sealing two hemispheres of the polyhedral casing to one another and/or the step consisting of immobilizing the portion of the flat flexible strip on a part of the outer surface of the polyhedral casing is carried out by bonding. Bonding takes advantage of the capillarity effect that is particularly powerful at the microscopic scale in order to guide the alignment of the components with one another.

Preferably, the method for the manufacture of the micro-robot according to the invention is suitable, more preferably is particularly suitable, even more preferably is designed and particularly advantageously is specially designed, to manufacture a micro-robot intended to form part of a programmable ensemble of micro-robots forming a three-dimensional structure with modulable geometry.

Any characteristic of the micro-robot according to the invention can be directly transposed to the manufacturing method according to the invention and vice versa.

### BRIEF DESCRIPTION OF THE FIGURES

Other advantages and features of the invention will become apparent on reading the detailed description of implementations and embodiments that are in no way limitative, and from the following attached drawings:

FIG. 1a is a diagrammatic representation of a micro-robot according to the invention,

FIG. 1b is a diagrammatic representation of a micro-robot according to the invention in which the casing is not shown,

FIG. 2a is a diagrammatic representation of the flexible strip, comprising a single tab, of the micro-robot shown in FIG. 1a,

FIG. 2b is a diagrammatic representation of the flexible strip, comprising several tabs, of the micro-robot shown in FIG. 1b,

FIG. 3a is a photograph of the flexible strip, comprising a single tab, of the micro-robot shown in FIG. 1a and of the tab shown diagrammatically in FIG. 2a,

FIG. 3b is a photograph of the casing of a micro-robot,

FIG. 4a is a representation of a reversible fastening device comprising one pair of electrodes,

FIG. 4b is a representation of a reversible fastening device comprising two pairs of electrodes,

FIG. 4c is a representation of a reversible fastening device comprising eight pairs of electrodes,

FIG. 5 is a simplified diagrammatic representation of the electronic circuit of the control unit of a micro-robot,

FIG. 6 is a diagrammatic representation in an exploded view of the micro-robot shown in FIG. 1a.

### DETAILED DESCRIPTION

As the embodiments described hereinafter are in no way limitative, it is possible in particular to consider variants of the invention comprising only a selection of characteristics described, in isolation from the other characteristics described (even if this selection is isolated within a sentence containing these other characteristics), if this selection of characteristics is sufficient to confer a technical advantage or to differentiate the invention with respect to the prior art. This selection comprises at least one, preferably functional, characteristic without structural details, or with only a part of the structural details if this part alone is sufficient to provide a technical advantage or to differentiate the invention with respect to the state of the prior art.

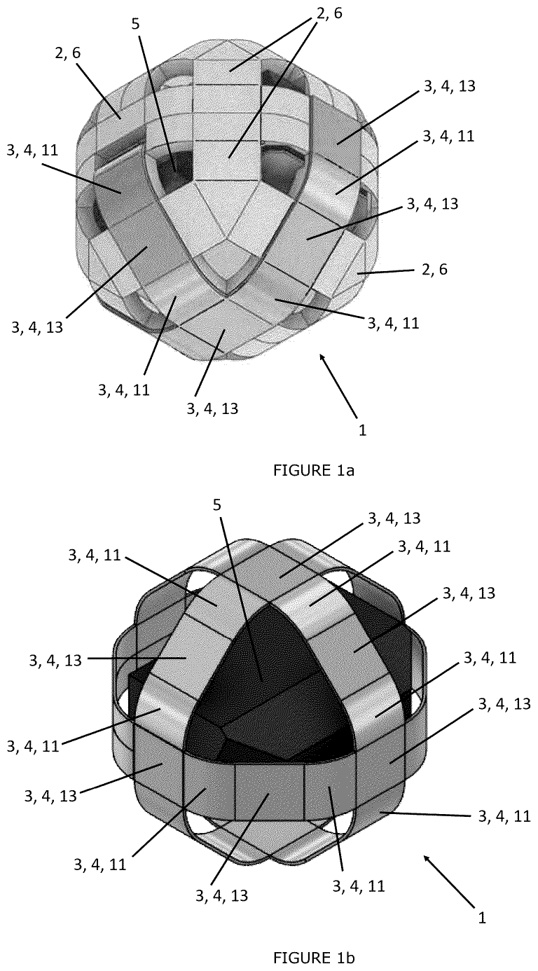

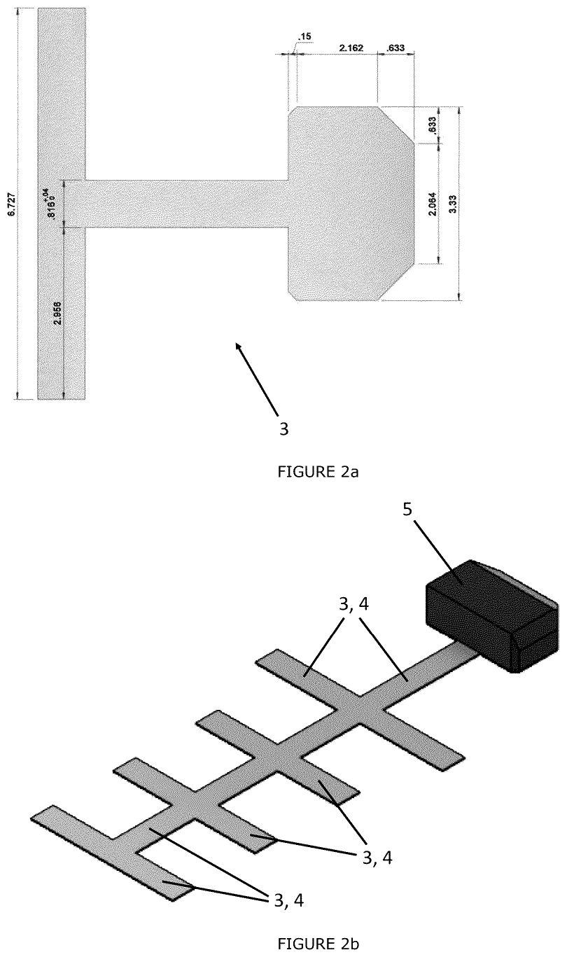

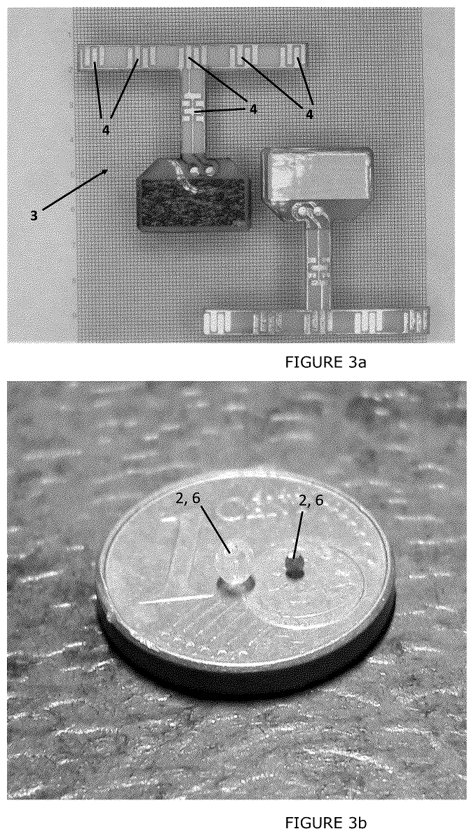

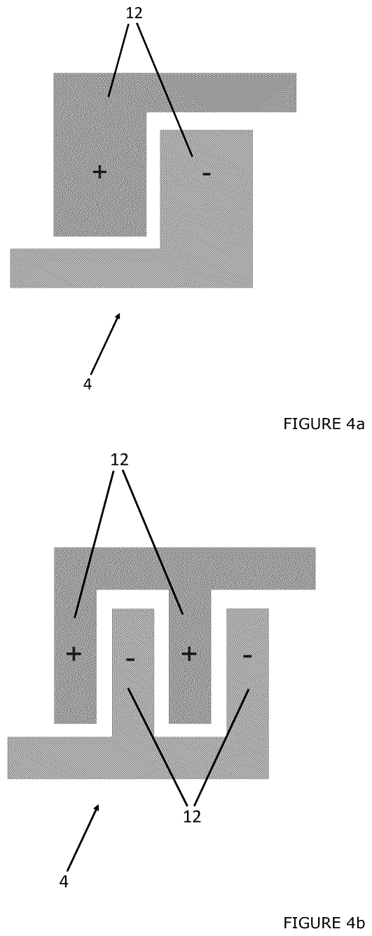

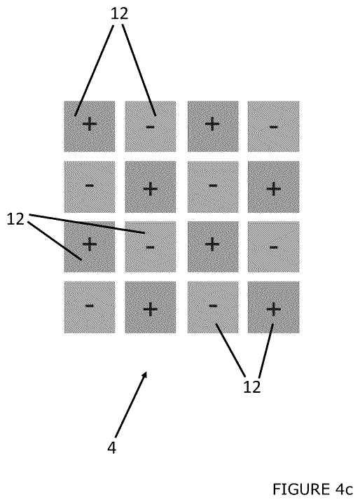

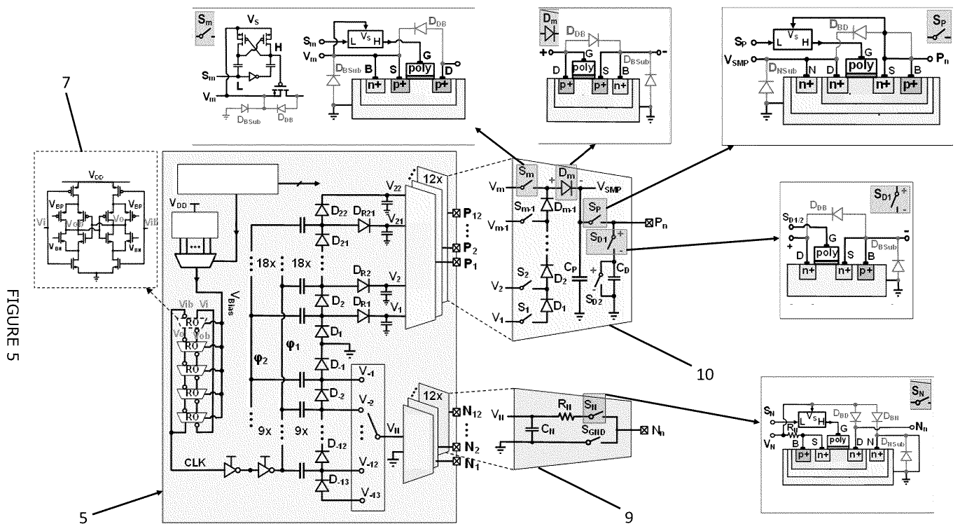

With reference to FIGS. 1 to 6, an embodiment of a micro-robot 1 according to the invention is presented. The micro-robot 1 is intended to form part of a programmable ensemble of micro-robots 1 forming a three-dimensional structure with modulable geometry. Each micro-robot 1 of the ensemble comprises a polyhedral casing 2 and a flexible strip 3. The flexible strip 3 comprising a set of reversible fastening devices 4, called RFDs 4. The RFDs 4 extend along the whole of the flexible strip 3. The strip 3 comprises a printed circuit extending along the flexible strip 3. The flexible strip 3 extends between a control unit 5 and along an outer surface 6 of the polyhedral casing 2 on a part of which to which it extends. The flexible strip 3 is electrically connected to the control unit 5. The control unit 5 is contained in the polyhedral casing 2. The control unit 5 is arranged to electrically supply each of the RFDs 4 individually. According to the non-limitative embodiment, each micro-robot 1 comprises twelve RFDs 4.

The shape of the polyhedral casing 2, and therefore the shape of the micro-robots 1, must allow the aggregation or the fastening of several robots in order to form a dense lattice by reducing the empty spaces in the programmable ensemble. Moreover, such a shape also makes it possible for the micro-robots 1 to move around, or the surface, of the others more easily.

When a first micro-robot 1 is contiguous with a second micro-robot 1, an RFD 4 of the first micro-robot 1 is activated by the control unit 5 of the first micro-robot 1 and an RFD 4 of the second micro-robot 1 is also activated so that a reciprocal attractive force is exerted between the RFDs 4 of the first and second micro-robots 1. If neither of the first and second micro-robots 1 is linked to a third, or to several other, micro-robots 1, the first micro-robot 1 can move along the part of the outer surface of the second micro-robot 1 formed by the flexible strip 3 in the direction of the RFD 4 of the second micro-robot 1 that is activated. Once face-to-face, the activated RFDs 4 of the first and second micro-robots 1 can be immobilized against one another. Once the RFDs 4 of the first and second micro-robots 1 are immobilized against one another, the activation of an RFD 4 neighbouring the RFD 4 of the already-activated second micro-robot 1, preferably followed by the gradual deactivation of the RFD 4 of the second already-activated micro-robot 1, will cause a new movement of the first micro-robot 1 along the part of the outer surface of the second micro-robot 1 formed by the flexible strip 3 in the direction of the RFD 4 of the second micro-robot 1 that has just been activated.

The activation of an RFD 4, or of several RFDs 4, by the control unit 5 of a micro-robot 1 causes the emission of an electrostatic field by the RFD 1, or the RFDs 4. As long as the electrostatic field is emitted, the RFDs 4 in contact remain immobilized against one another. The deactivation of an RFD 4, or the cessation of the electrical supply of an RFD 4, leads to the detachment of the RFDs 4 in contact, immobilized against one another.

According to the embodiment, the size of the RFDs 4 is of the order of 800 μm², it is preferably, less than or equal to one mm². Such a size of RFD has the effect of taking the best advantage of the electrostatic forces, which are stronger at a small scale. Moreover, the size of the micro-robot 1, which goes hand in hand with its weight, is of the order of 3 mm according to the embodiment, it is, preferably, less than 5 mm.

The flexible strip 3 has an alternation of flat zones 13 and curved zones 11. Two successive flat zones 13 are connected together by a curved zone 11. The flexible strip 3 comprises an inner layer. This inner layer is in contact with a part of the outer surface 6 of the polyhedral casing 2.

Each RFD 4 is formed by at least one pair of adjacent electrodes 12 with reverse polarity. The attractive force is an electrostatic force exerted by one or more electrodes 12 with negative polarity of an RFD 4 of a first micro-robot 1 on at least one electrode 12 with positive polarity of an RFD 4 of another micro-robot neighbouring the first.

The flexible strip 3 also comprises an intermediate layer, comprised between the inner layer and the outer layer. This intermediate layer comprises an electrically conductive material. The electrically conductive material of the intermediate layer forms electrical tracks supplying the set of the RFDs 4 of a micro-robot 1. The electrically conductive material of the intermediate layer also forms the RFDs 4.

The flexible strip 3 also comprises an electrically isolating outer layer. This outer layer has the effect of avoiding a short-circuit between two RFDs 4 of two micro-robots 1 that are side-by-side and attached together. When two RFDs 4 of two micro-robots 1 are side-by-side and attached together, the part of the outer layer of the flexible strip 3 of each of the two micro-robots 1 in question is intended to come into contact with at least a part of the outer layer of the flexible strip of another micro-robot.

According to a non-limitative embodiment, the set of the micro-robots 1 intended to form the assembly or forming the assembly are stacked or rest on a hollow support that acts as a reserve of micro-robots 1. The support can be linked to a to a central unit comprising a processor. According to a non-limitative embodiment, a base of the support comprises a lattice of RFDs 4. Each RFD 4 of the support constitutes a fastening zone of an RFD 4 of a micro-robot of the assembly. The base of the support can form a grid.

The support receives items of information relating to the shape of the ensemble to be assembled. The items of information are transmitted step by step from a micro-robot 1 to a contiguous micro-robot 1 against which it is immobilized. The items of information transit between two RFDs 4 in contact, immobilized against one another. The items of information thus flow from the support to the whole of the programmable ensemble.

The micro-robots 1 are thus linked by capacitive coupling from the support then from micro-robot 1 to micro-robot 1. According to the embodiment, a digital signal modulated by the support is transmitted micro-robot 1 stack by micro-robot 1 stack. Each micro-robot 1 of the assembly thus receives the signal. For example, each micro-robot 1 demodulates the signal that it receives, then remodulates it to transfer it to all its neighbours in the direction of the signal. Preferably, each robot has onboard a finite state machine arranged to process these signals and to activate or deactivate one or more of its RFDs 4 as a function of the predefined assembly plan.

In order to change the assembly configuration, the support sends a new signal, different from the preceding one, over the entirety or only over a part of the coordinates of the grid corresponding to the stacks of micro-robots 1 the state of which must be modified.

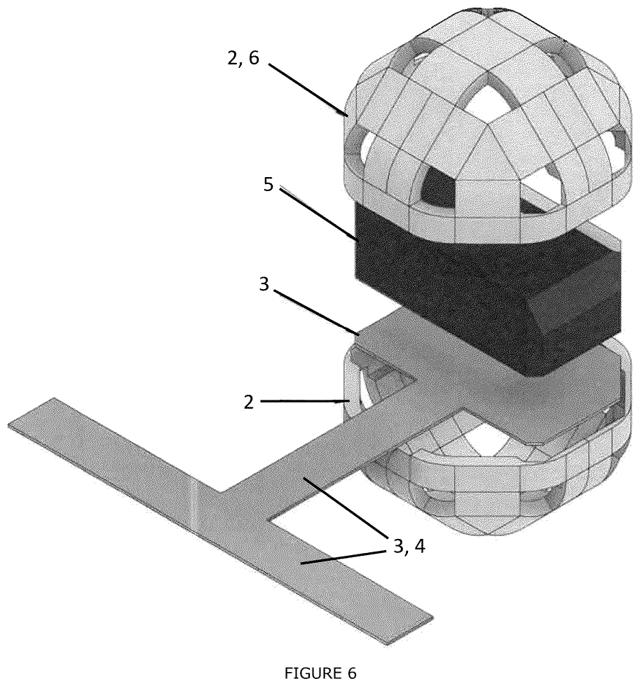

With reference to [FIG. 5], an embodiment of the electronic circuit of the control unit 5 of a micro-robot 1 is presented. The control unit 5 comprises, among other things, a square pulse generator 7 assembly, referenced RO, arranged to supply a charge-pump converter with power. The control unit also comprises a multiplexer 9, per electrode 12 with negative polarity, arranged so as, starting from a negative output voltage, referenced V_{N}, of the charge-pump converter, to generate a high negative voltage, referenced Nn. The control unit 5 also comprises a multiplexer 10, per electrode 12 with positive polarity, arranged so as, starting from a positive output voltage, referenced Vₘ, of the charge-pump converter, to generate a high positive voltage, referenced Pn. The voltage difference delivered by the control unit is of the order of 100 volts according to the embodiment.

The positive and negative charge-pumps are shown in [FIG. 5], generating respectively 40V and 70V. In order to obtain a low power, the clock signal generation uses a square pulse generator 7, modulated by the polarization voltage VBP/VBN. According to the embodiment, the control unit comprises twelve negative high-voltage multiplexers 9 and twelve positive high-voltage multiplexers 10 that select the appropriate positive and negative voltages starting from the outputs of the charge pump for the electrostatic actuation and make it possible to overcome several electronic circuit challenges.

This embodiment makes it possible to charge the charge-pump converter only once, at initialization of the micro-robot 1, and to connect or disconnect the RFDs 4 via an independent circuit, ensuring agility and rapidity of the switchover, and reduces the energy losses associated with leakage during charging and discharging of the charge-pump converter.

For the positive high voltage, the control signals of the pass gates S1-Sm are level-shifted. For a given PMOS pass gate corresponding to a positive output voltage, the bodies S1-Sm must be connected to V1-Vm, which leads to a significant DDB direct diode polarization current when the output voltage on Pn is greater than that of the inner nodes V1-Vm. The diodes D1-Dm have the effect of blocking this current. The diodes D1-Dm are arranged in series in order to equalize their reverse polarization state, reducing the diode voltage potential and reducing their leakage to levels below one picoampere.

When a voltage switch, referenced Si or i varies from 1 to m, increases the output voltage of Pn, drawing a significant call charge from the charge pump, Vi and other voltages of the electrode 12 break down. Consequently, the rate of charge transfer from V1-Vm to Pn must be carefully limited in order to ensure stable voltages to all the electrodes 12 contained in the RFDs 4. A switch SP and a condenser CP are used to resolve this problem by creating an equivalent resistance modulated by the frequency of the switch SP. SP is switched without overlap with Si in order to avoid a direct path from Vi to Pn until Pn has stabilized. The control signal for SP is also level-shifted. Given that the voltage VSMP on CP changes rapidly during a charge transfer cycle, it cannot be followed by a level shifter. SP is implemented with an NMOS transistor and its control signal is level-shifted with respect to VPn, which is slow and can be followed. For similar reasons, S1-Sm are implemented with PMOS transistors and their control signals are shifted from Vi.

With the addition of the diodes D1-Dm, the charge pump can only draw the output voltage Pn upwards. Without charge current CC, the voltage on Pn will reduce extremely slowly by leakage. Consequently, an intentional discharge path is also implemented with a switching resistor SD1, SD2 and CD. By using the regular supply voltage for controlling the switches SD1 and SD2, the charge transfer to CD (VDD-Vth) per cycle is limited, and Pn discharges progressively. When they are not discharging, SD1 and SD2 are switched off, which significantly reduces leakage.

By using the same approach for the negative charge pump, the switches Sp, SD1 and SD2 would need to be PMOSs, which is not possible because their sink n, connected to the negative voltage Nn, would short-circuit Psub via the diode. A simpler multiplexer that selects between Vn and GND was therefore implemented. In this multiplexer, the level shifter for Sn is referenced to Vn, since a stable voltage is concerned. The charge transfer between Vn and Nn is limited by the Rn poly resistor. When Sn is deactivated, the source voltage of Sn is Vs, Sn is equal to Vn while Vd, Sn is equal to Nn which is equal to zero volts. When Sn is activated, the level shifter applies a gate voltage Vg, Sn is equal to the voltage difference Vn minus VDD and the source voltage of Sn increases rapidly up to the voltage Vn minus VDD minus Vth, powering down the switch and automatically limiting the charge transfer. Vs, Sn will then drop slowly as the charge flows through Rn, reactivating Sn and transferring the charge from Nn to Vn in a controlled manner. The negative multiplexer 9 supplies a selection of differential voltage of the order of 40V while the positive multiplexer 10 supplies a control with a step of the order of 3V. In order to allow a value of VN depending on the application, it is determined by a wired connection between the negative outlet of the pump (V₋₁ to V₋₁₃) and Vn.

Of course, the invention is not limited to the examples that have just been described and numerous modifications can be made to these examples without departing from the scope of the invention.

In addition, the different characteristics, forms, variants and embodiments of the invention can be combined with one another according to various combinations inasmuch as they are not incompatible or mutually exclusive.

1-10. (canceled)

11. A micro-robot intended to form part of a programmable ensemble of micro-robots forming a three-dimensional structure with modulable geometry, said micro-robot comprises:
a polyhedral casing, and
a flexible strip:
comprising a set of reversible fastening devices called RFDs, each comprising at least one pair of electrodes,
extending between a control unit, contained in the polyhedral casing and arranged to supply the RFDs, and at least a part of an outer surface of the polyhedral casing on which the flexible strip extends;
the micro-robot is arranged so that at least one RFD emits an electrostatic field by polarization of the at least one pair of electrodes of the at least one RFD;
the control unit is arranged to activate and deactivate, individually and for each of the RFDs, the polarization of the at least one pair of electrodes of the at least one RFD so as to activate or deactivate the emission of the electrostatic field by the at least one RFD.

12. The micro-robot according to claim 11, wherein the flexible strip comprises a printed circuit electrically connecting the RFDs to the control unit.

13. The micro-robot according to claim 11, wherein the flexible strip comprises an alternation of flat zones and curved zones; two successive flat zones are connected together by a curved zone.

14. The micro-robot according to claim 11, wherein the flexible strip comprises:
an inner layer at least a part of which is in contact with the at least one part of the outer surface of the polyhedral casing,
an outer, electrically isolating layer; the outer layer constitutes a part of the outer surface of the micro-robot, and an intermediate layer, comprised between the inner layer and the outer layer, comprising an electrically conductive material.

15. The micro-robot according to claim 14, wherein the intermediate layer comprises:
electrical tracks formed by the electrically conductive material, and the RFDs formed by the conductive material.

16. The micro-robot according to claim 11, wherein the electrodes of the at least one pair of electrodes are adjacent and have reverse polarity.

17. The micro-robot according to claim 11, wherein the control unit is arranged to generate a supply voltage difference of the RFDs, called high voltage, greater than or equal to 80 volts.

18. The micro-robot according to claim 17 wherein the control unit comprises:
at least one square pulse generator arranged to supply a charge-pump converter, and a multiplexer, per electrode with negative polarity, arranged so as to, starting from a negative output voltage of the charge-pump converter, generate a high negative voltage and a multiplexer (10), per electrode with positive polarity, arranged so as to, starting from a positive output voltage of the charge-pump converter, generate a high positive voltage.

19. A programmable ensemble of micro-robots according to claim 11, forming a three-dimensional structure with modulable geometry, said micro-robots each comprising:
a polyhedral casing,
a flexible strip:
comprising a set of reversible fastening devices called RFDs, each comprising at least one electrode, extending between a control unit, contained in the polyhedral casing and arranged to supply the RFDs, and at least a part of an outer surface of the polyhedral casing on which the flexible strip extends;
for each of the micro-robots, at least one RFD is arranged to emit an electromagnetic field by polarization of the at least one electrode of the at least one RFD and, for a micro-robot in question situated in proximity to another micro-robot, the electrostatic field emitted by the at least one RFD of the micro-robot in question, emitting an electrostatic field exerts a reciprocal attractive force on the at least one RFD, of the micro-robot neighbouring the micro-robot in question, emitting an electrostatic field, and reciprocally, such that the micro-robot in question moves towards and/or is immobilized against the other micro-robot and/or vice-versa and/or reciprocally;
the control unit is arranged to activate and deactivate, individually and for each of the RFDs, the polarization of the at least one pair of electrodes of the at least one RFD so as to activate or deactivate the emission of the electrostatic field by the at least one RFD.

20. A method for the manufacture of a micro-robot according to claim 1, said micro-robot being intended to form part of a programmable ensemble of micro-robots forming a three-dimensional structure with modulable geometry comprising the steps consisting of: electrically connecting a control unit to a flat flexible strip (3) comprising a set of reversible fastening devices (4), called RFDs, each comprising at least one pair of electrodes (12), enclosing the control unit and a part of the flexible strip adjacent to the control unit in a polymer layer in order to immobilize the control unit on the flexible strip, sealing two hemispheres of a polyhedral casing (2) inside which the control unit is housed; the flat flexible strip passing, by means of an opening, through the polyhedral casing, such that a portion of the flat flexible strip extends outside the polyhedral casing, and folding and immobilizing the portion of the flat flexible strip extending outside the polyhedral casing such that it hugs the shape of the polyhedral casing and extends over a part of an outer surface of the polyhedral casing.
